(19) United States
(12) Patent Application Publication
(10) Pub. No.: US 2011/0083129 A1
(43) Pub. Date: Apr. 7, 2011

(54) MANAGEMENT SYSTEM, MANAGEMENT APPARATUS, MANAGEMENT METHOD, AND COMPUTER READABLE RECORDING MEDIUM STORING THE MANAGEMENT PROGRAM

(75) Inventor: Atsushi MASAKI, Kawasaki (JP)

(73) Assignee: FUJITSU LIMITED, Kawasaki-shi (JP)

(21) Appl. No.: 12/896,218

(22) Filed: Oct. 1, 2010

(30) Foreign Application Priority Data
Oct. 2, 2009 (JP) 2009-230601

(51) Int. Cl. G06F 9/445

(52) U.S. Cl. 717/175

(57) ABSTRACT

By having a version information storage section that stores respective version information on the program installed in the data relay apparatus; a requirement information storage section that stores, for each of the plurality of versions of the program, requirement information for changing that version to a different version; a confirmation section that checks whether a version of the program application of which is instructed can be applicable to the data relay apparatuses by looking up the version information stored in the version information storage section and the requirement information stored in the requirement information storage section; and an install processing section that installs, in response to the confirmation section determining that the program is applicable, the program in the instructed version to the data relay apparatuses, the labor for the maintenance is reduced and thee maintenance cost is reduced.

### CROSS-REFERENCE TO RELATED APPLICATIONS

This application is based upon and claims the benefit of priority of the prior Japanese Patent Application No. 2009-230601, filed on Oct. 2, 2009, the entire contents of which are incorporated herein by reference.

### FIELD

The embodiments discussed herein are directed to a technique for managing, in a data transmission system to which a plurality of data relay apparatuses are connected, programs installed in the data relay apparatuses.

### BACKGROUND

Recently, storage area networks (SANs) are known, which are networks constructed from storages (e.g., hard disk devices and magnetic tape devices) and computers (e.g., servers) connected through a serial SCSI protocol, such as the fibre channel.

Furthermore, upon constructing such an SAN, a relay apparatus, generally known as a “switch” is deployed between the server and the storages for achieving a flexible system configuration (see Patent References 1 and 2 listed below).

A switch is adapted to handle transmission and reception of data between servers and storages, wherein various controls, such as protocol control and status management, are carried out by executing firmware by a main processor.

In a larger-scale SAN constructed by a plurality of SANs (fabrics), a plurality of switches are often deployed in each of the fabrics.
Patent Document 1: Japanese Laid-Open Patent Application No. 2004-252806
Patent Document 2: Japanese Laid-Open Patent Application No. 2003-131897

In an SAN as described above, firmware update for a plurality of switches is carried out by a maintenance engineer logging in to each of the switches and applying the firmware to that switch, one after another. More specifically, the maintenance engineer connects their own maintenance personal computer (PC) to each switch and types commands for commencing the installation.

Such a firmware installation procedure is tedious. Especially, the higher the number of switches becomes, the longer the time required for the update procedure of the firmware becomes, which results in an increase in the maintenance cost.

Furthermore, in some cases, new firmware cannot be directly applied to a switch that has firmware already installed. In such a case, intermediate versions of firmware (intermediate firmware) are required to be installed to the switch before installing the new firmware. That is, a plurality of stepwise installations are required, which further makes the update procedure of firmware painstaking.

Furthermore, in a SAN, access paths are generally duplexed between a server and storages, and accordingly, two or more switches are placed in a paired configuration. Thus, a maintenance engineer must install firmware to each switch one after another with a certain time interval such that any accesses for routine jobs from the server to the storages are not blocked. Thus, cares must be taken for the timing for maintenance for switches, which also makes the task laborious.

Furthermore, when the main body of a switch is swapped for some reason, such as failure, aversion of firmware installed in the new switch may be different from the version of firmware installed in the previous switch. In such a case, it is desired to install, to the new switch, the same version of firmware as the version of firmware of the previous switch, since this version of firmware is well-proven. In such a case, the maintenance engineer must check the version number of firmware of the previous switch and obtain that version of firmware, which further makes the task laborious.

### SUMMARY

Accordingly, an aspect of the present disclosure is a management system for managing, in a data transmission system to which a plurality of data relay apparatuses are connected, a program for the data relay apparatus, including: a program storage section that stores a plurality of versions of the program; a version information storage section that stores respective version information on the program installed in each of the data relay apparatuses; a requirement information storage section that stores, for each of the plurality of versions of the program, requirement information for changing that version to a different version; an instruction information entry section that receives version information of the version of the program to be applied to the data relay apparatuses as instruction information; a confirmation section that checks whether the version of the program instructed by the instruction information received through the instruction information entry section can be applicable to the data relay apparatuses by looking up the version information stored in the version information storage section and the requirement information stored in the requirement information storage section; and an install processing section that installs, in response to the confirmation section determining that the program is applicable, the program in the instructed version to the data relay apparatuses.

Furthermore, another aspect of the present disclosure is a management apparatus for managing, in a data transmission system to which a plurality of data relay apparatuses are connected, a program for the data relay apparatuses, including: a version information storage section that stores respective version information on the program installed in each of the data relay apparatuses; a requirement information storage section that stores, for each of the plurality of versions of the program, requirement information for changing that version to a different version; a confirmation section that checks whether the version of the program application of which is instructed can be applicable to the data relay apparatuses by looking up the version information stored in the version information storage section and the requirement information stored in the requirement information storage section; and an install processing section that installs, in response to the confirmation section determining that the program is applicable, the program in the instructed version to the data relay apparatuses.

A further aspect of the present disclosure is a management method for managing, in a data transmission system to which a plurality of data relay apparatuses are connected, a program for the data relay apparatuses, including: an instruction information input step that receives version information of the program to be applied to the data relay apparatuses as instruction information; a confirmation step that confirms whether the program of the version instructed by the instruction information received by the instruction information input step can be applicable to the data relay apparatuses by looking up respective version information on the programs installed in each of the data relay apparatuses and requirement information restricting to a different version for each of the plurality of versions of the program; and an install processing step that installs, in response to the confirmation step determining that the program is applicable, the program in the instructed version to the data relay apparatuses.

A further aspect of the present disclosure is a computer readable recording medium recording this management program making a computer execute a management function for managing, in a data transmission system to which a plurality of data relay apparatuses are connected, a program for the data relay apparatuses, a selection step that selects the program in a version to be installed to the data relay apparatus among a plurality of versions, for the program in the version application of which is instructed can be applicable to the data relay apparatuses by looking up the version information stored in the version information storage section and the requirement information stored in the requirement information storage section; and an installation step that installs the program selected in the selection step to the data relay apparatus.

The object and advantages of the invention will be achieved and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram schematically illustrating a management system as one example of an embodiment;

FIG. 2 is a diagram schematically illustrating a storage system provided with the management system as one example of an embodiment;

FIG. 3 is a diagram schematically illustrating the hardware configuration of a switch in the management system as one example of an embodiment;

FIG. 4 is a diagram schematically illustrating the configuration of a proxy switch of the management system as one example of an embodiment;

FIG. 5 is a diagram illustrating a firmware management table in the management system as one example of an embodiment;

FIG. 6 is a diagram illustrating a firmware management table in the management system as one example of an embodiment;

FIG. 7 is a diagram schematically illustrating an example of the configuration of a base switch in the management system as one example of an embodiment;

FIG. 8 is a flowchart illustrating a technique for managing and registering firmware in each switch in the management system as one example of an embodiment;

FIG. 9 is a flowchart illustrating a technique for updating a firmware management table in the management system as one example of an embodiment;

FIG. 10 is a flowchart illustrating a technique for changing firmware in each switch in the management system as one example of an embodiment; and

FIG. 11 is a flowchart illustrating processing for swapping switches in the management system as one example of an embodiment, which is a diagram schematically illustrating an example of the configuration of a logging information capturing apparatus as one this embodiment of the present disclosure.

### DESCRIPTION OF EMBODIMENT(S)

Hereinafter, embodiments of a management system, a management apparatus, a management method, and a management program will be described with reference to the drawings.

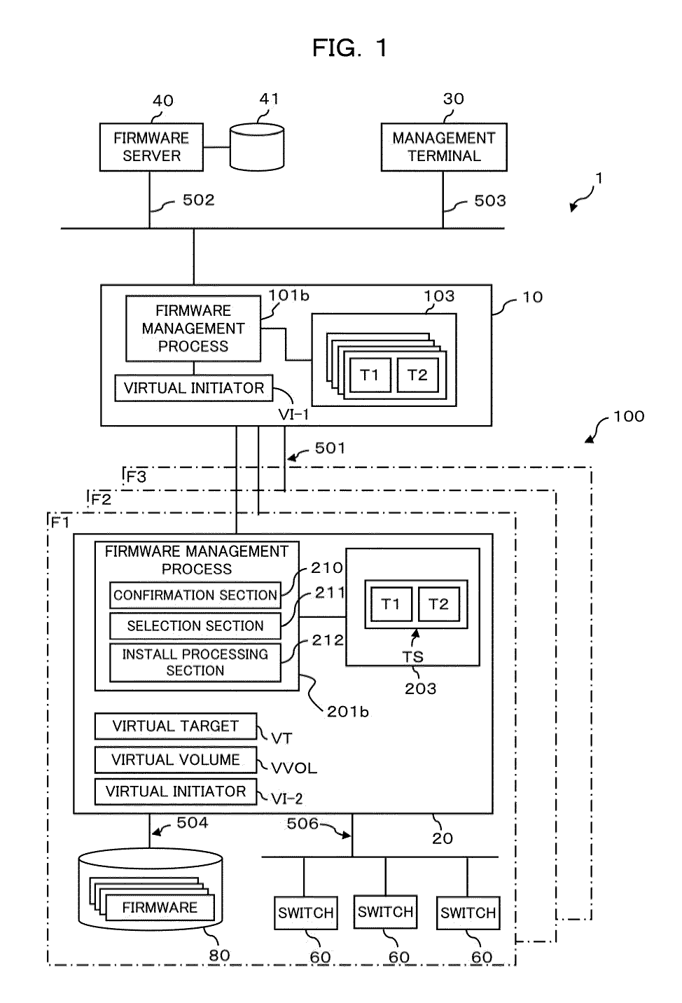

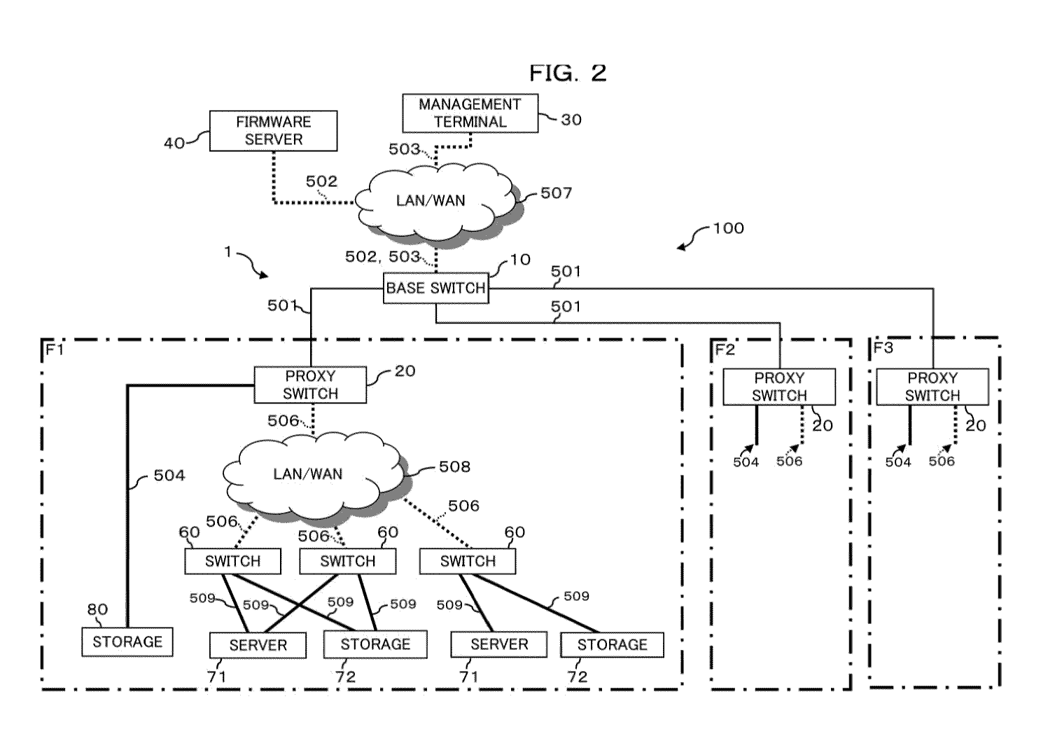

FIG. 1 is a diagram schematically illustrating a management system as one example of an embodiment, and FIG. 2 is a diagram schematically illustrating a storage system provided with this management system.

A storage system 100 is constructed by a plurality of servers 71 and a plurality of storages 72 connected through switches 60 as data relay apparatuses and a communication network, so that sharing of storage areas in the storages 72, data protection by means of redundancy, and the like is achieved.

In other words, the storage system 100 functions as a data transmission system wherein the plurality of switches 60 are connected.

The management system 1 is provided in the storage system 100, and is adapted to manage firmware (program) in each switch 60 provided in the storage system 100.

In the example depicted in FIG. 2, the storage system 100 includes a plurality of fabrics (SANs: management regions) F1-F3, and in each of these fabrics F1-F3, servers 71 and storages 72 are connected through switches 60.

Note that, although an example in which the storage system 100 includes three fabrics F1-F3 in this embodiment, this is not limiting and the storage system 100 may include fewer or more than three fabrics.

The reference symbols F1-F3 are used hereinafter when reference is made to one of the fabrics while reference symbol F is used for reference is made to any of the fabrics.

As depicted in FIG. 1, the management system 1 is configured to include a base switch (second management apparatus) 10, proxy switches (first management apparatuses) 20, a management terminal 30, and a firmware server 40.

The firmware server 40 is connected to the base switch 10 through a communication link 502 and a local area network (LAN)/wide area network (WAN) 507, and the management terminal 30 is connected to the base switch 10 through a communication link 503 and the LAN/WAN 507.

Furthermore, each fabric F1-F3 is provided with a proxy switch 20, and the proxy switch 20 is connected to the base switch 10 through a communication link 501.

In each of the fabrics F, a storage 80 is connected to the proxy switch 20 through a communication link 504, and switches 60 in that fabric F are connected to the proxy switch 20 through communication links 506 and an LAN/WAN 508.

Furthermore, servers 71 and storages 72 are connected to each switch 60 through communication links 509. Furthermore, some servers 71 and storages 72 are connected through the plurality of switches 60 and the communication links 509, providing redundant communication paths.

Note that the communication links 502, 503, and 506 are links on the basis of the Ethernet® standard in the example depicted in FIG. 2, and the communication links 501, 504, and 509 are links on the basis of the fibre channel (FC) standard.

Note that only the configuration of the fabric F1 is depicted in the example depicted in FIGS. 1 and 2 for brevity, and other fabrics F2 and F3 are configured in the manner similar to the fabric F1. Furthermore, LAN/WANs 507 and 508 are omitted from illustration in the example depicted in FIG. 1 for brevity.

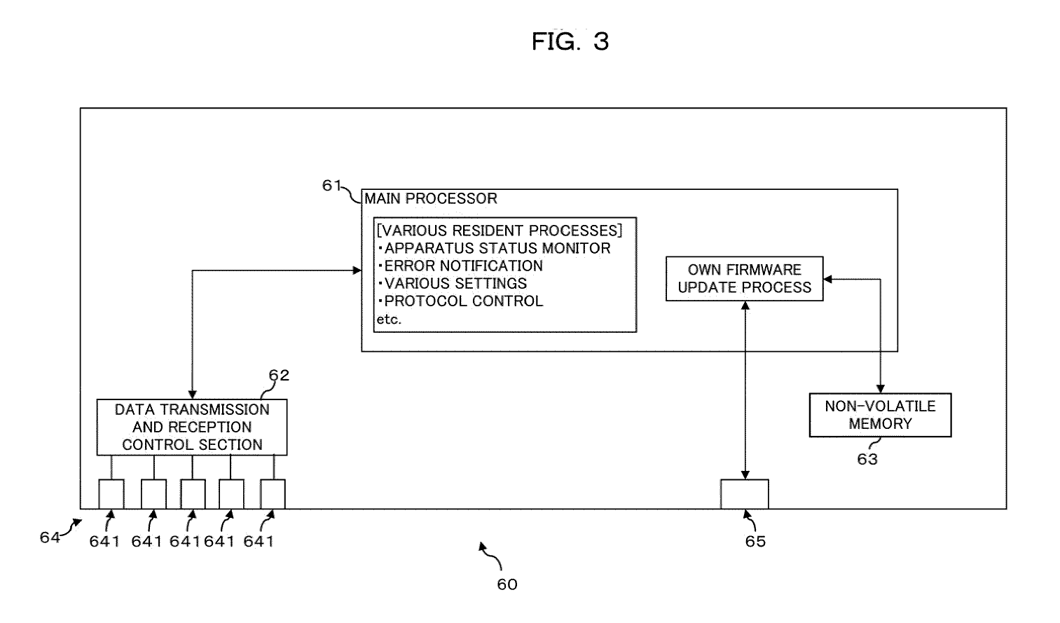

FIG. 3 is a diagram schematically illustrating an example of the hardware configuration of a switch in this management system.

A switch 60 is connected to the servers 71, the storages 72, and other switches 60 through the communication links 509, and is adapted to perform data transmission and reception control for relaying data and various instructions among servers 71, the storages 72, and other switches 60. The respective switches 60 is configured to include a main processor 61, a data transmission and reception control section 62, a non-volatile memory 63, an FC interface 64, and an Ethernet interface 65, as depicted in FIG. 3.

The FC interface 64 is an interface through which FC-compliant appliances are connected, and is configured to include a plurality of (five, in the example depicted in FIG. 3) ports 641. The ports 641 are connected to the servers 71, the storages 72, and other switches 60 through the communication links 509, for example.

The data transmission and reception control section 62 is adapted to implement data transmission and reception processing among the appliances connected to the FC interface 64. Furthermore, data transmission and reception between a server 71 and a storage 72 connected to the FC interface 64, for example, is typically achieved under the control of the data transmission and reception control section 62, without any intervention by the main processor 61 that will be described later.

The Ethernet interface 65 is an interface through which Ethernet-compliant appliances are connected, and is connected to the proxy switch 20 through the communication link 506, for example. Note that although the proxy switch 20 is depicted to being connected to the switches 60 through the LAN/WAN 508 in the example depicted in FIG. 2, the connection between the Ethernet interface 65 and the proxy switch 20 may be practices in various manners.

The non-volatile memory 63 is a storage area wherein various pieces of data and programs are stored. The non-volatile memory 63 stores firmware (program) for implementing various functions of the switches 60.

The main processor 61 is adapted to implement various controls and functions of the switch 60 by executing the firmware stored in the non-volatile memory 63. For example, the main processor 61 monitors statuses of various apparatuses connected through the FC interface 64 by executing firmware, and, in response to detection of some abnormality during the monitoring, notifies the management terminal 30 that will be described later or the like of an error. Furthermore, the main processor 61 performs various settings, protocol controls, and the like, by executing the firmware. Thus, in the switches 60, the main processor 61 implements zoning by collectively managing types and various pieces of information of apparatuses connected to the ports 641 or limiting access to data, for example. Note that these functions are known as functions (resident processes) of switches, and the detailed description thereof will be omitted.

Furthermore, the firmware executed by the switch 60 is updated where necessary, for various purposes, such as enhancing the functions of the switch 60, improving security, improving the stability of operation. That is, the same type of firmware applied to the same switches 60 may be different in terms of the date and time of update (creation).

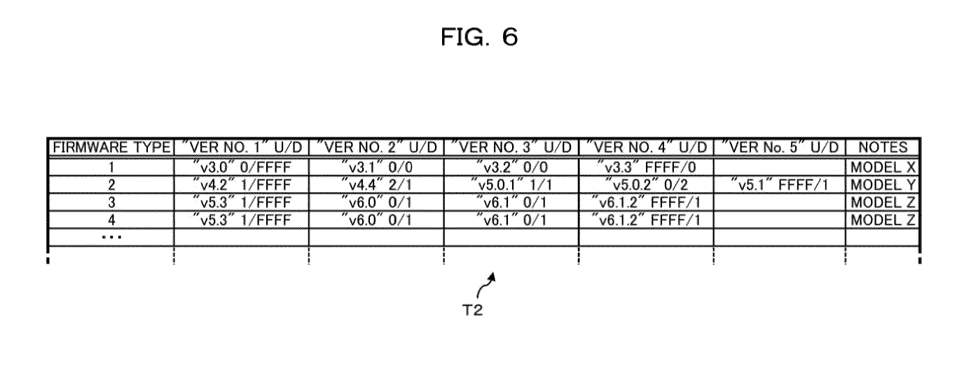

In the management system 1, a plurality of pieces of firmware created (updated) in such a manner are distinguished from each other using “versions”. Such versions may be expressed by characters having an explicit order, such as numerical characters or alphabetical characters, and the chronological orders of pieces of firmware can be expressed by numerical characters and the like. In this embodiment, alphanumerical characters and symbols are used alone or in combination, and a version denoted by a numerical character of a greater number is a piece of firmware created more recently (is newer). For example, in the example depicted in FIG. 6, as in “v3.0”, firmware is denoted by a character “v” expressing a version, followed by a numerical character “3”, a symbol “.” (period), and a numerical character “0”. The firmware of “v3.1” is newer than the firmware of “v3.0”.

Furthermore, in this embodiment, the chronological order of versions of the same type of firmware is expressed using “version numbers” (sequential numbers of versions). Such version numbers may be expressed by characters having an explicit order, such as numerical characters or alphabetical characters, and the chronological orders of pieces of firmware can be expressed by numerical characters and the like. In this embodiment, natural numbers are used alone or in combination for denoting version numbers, and a version denoted by a numerical character of a greater number is a piece of firmware created more recently (is newer).

The relations between versions and version numbers are maintained in a firmware management table T2 that will be described later (see FIG. 6).

Note that the relations between versions and version numbers in the firmware management table T2 may be created by an administrator, for example, when the system 1 is installed or a new version of firmware is created and registered to the firmware server 40. Furthermore, such processing may be automatically executed by firmware management process 101b or firmware management process 201b, for example. When such processing is automatically executed, the order of a plurality of pieces of firmware may be determined on the basis of file names, attribute information (version name), time stamps indicating creation date and time, for example, that are set for pieces of firmware created.

The main processor 61 also executes own firmware update process that replace (upgrades or downgrades) a version of firmware stored in the non-volatile memory 63 with another version of the firmware.

The own firmware update process is executed by a proxy switch that will be described later, when an installation command is executed by that proxy switch after a remote login is established by the proxy switch, for example.

Note that installation of firmware to the switch 60 during the own firmware update process can be achieved by a known command or the like, and the detailed description thereof will be omitted. Hereinafter, installing firmware to a switch 60 may be referred to as “applying firmware”.

Furthermore, the main processor 61 includes a function to execute own firmware report process that sends version information (version number) of the version of firmware currently installed in the proxy switch 20 in response to a request from the proxy switch 20. The version information of firmware is stored in a predetermined area in the non-volatile memory 63 upon installation of the firmware, for example. The main processor 61 notifies the proxy switch 20 of the version information stored in that predetermined area in the non-volatile memory 63 upon this own firmware report process.

Note that any access from a server to a storage 72 in the same fabric F is made via a switch 60. Furthermore, it is assumed that the switches 60 have no virtual function in this embodiment.

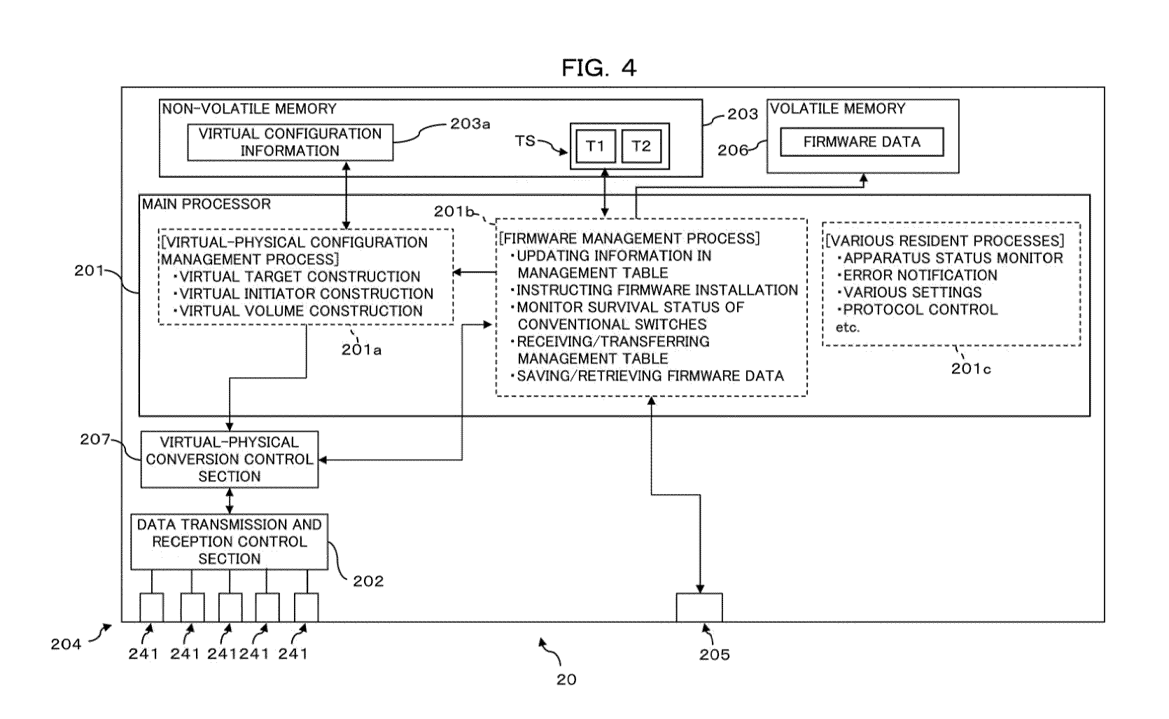

FIG. 4 is a diagram schematically illustrating an example of the configuration of a proxy switch in the management system.

A proxy switch 20 is provided in each fabric F, and is adapted to manage each piece of firmware in switches 60 in the same fabric F.

The proxy switch 20 is configured to include, as depicted in FIG. 4, a main processor 201, a data transmission and reception control section 202, a non-volatile memory 203, an FC interface 204, an Ethernet interface 205, a volatile memory 206, and a virtual-physical conversion control section 207.

The FC interface 204 is an interface through which FC-compliant appliances are connected, and includes a plurality of (five, in the example depicted in FIG. 4) ports 241. The base switch 10 and a storage 80 are connected to these ports 241 via a communication link 501 and a communication link 504 depicted in FIG. 2, for example.

The data transmission and reception control section 202 is adapted to implement data transmission and reception processing to and from the base switch 10 connected to the FC interface 24.

The storage (program storage section) 80 is a storage apparatus, such as a hard disk drive (HDD) or solid state drive (SSD), and is adapted to store various pieces of data. In this embodiment, firmware obtained by the proxy switch 20 from the firmware server 40 by way of the base switch 10 is stored in the storage 80, as will be described later.

Copies of versions of firmware of all version numbers of versions of firmware installed in the switches 60 in the same fabric F is stored in the storage 80. That is, the storage 80 functions as a storage apparatus for storing firmware.

In a predetermined storage area in the storage 80, copies of versions of firmware installed in each switch 60 in the fabric F accommodating that storage 80 is stored. Furthermore, any new firmware that is to be installed to the switches 60 is also stored in the storage 80.

By using the storage 80 for storing pieces of firmware, a large volume of data, i.e., firmware for a plurality of apparatuses, and firmware in a plurality of generations can be stored in a reliable manner.

Furthermore, redundancy and reliability can be improved by configuring the storage 80 in an RAID arrangement. Furthermore, when the proxy switch 20 is failed and swap is required, firmware stored in the storage 80 can be used for a new proxy switch. That is, the firmware needs not to be obtained from the firmware server 40, which is highly convenient.

Furthermore, redundancy of data can be easily achieved by copying firmware stored in the storage 80 into a plurality of storage areas. Furthermore, upon swapping the storage 80, firmware can be easily moved from the previous storage 80 to a new storage 80, which is highly convenient.

The Ethernet interface 205 is an interface through which Ethernet-compliant appliances are connected, for example, switches 60 are connected through the communication links 506.

The volatile memory 206 is adapted to temporarily store firmware obtained from the storage 80 under the control of the main processor 201 that will be described later, and functions as a firmware data storage area.

The non-volatile memory 203 is a storage area wherein various pieces of data and programs are stored. Virtual configuration information 203a and a firmware management table set TS are stored in the non-volatile memory 203. Here, the virtual configuration information 203a is information used by the main processor 201 that will be described later when executing virtual-physical configuration management process 201a. Furthermore, the firmware management table set TS is information used by the main processor 201 when executing the firmware management process 201b (the details of which will be described later). Furthermore, the non-volatile memory 203 also stores firmware (program) for implementing various functions of the proxy switch 20.

The virtual-physical conversion control section 207 is adapted to convert an access request to a virtual volume to an access request to a physical storage and transfer it to the data transmission and reception control section 202 (FC interface 204). Furthermore, the virtual-physical conversion control section 207 passes a request to a virtual target VT in the proxy switch 20 from a virtual initiator VI-1 in the base switch 10 that will be described later to the firmware management process 201b. Note that functions as the virtual-physical conversion control section 207 can be implemented by known techniques, and are configured as a large scale integration (LSI), for example.

The main processor 201 is adapted to implement various controls and functions of the proxy switch 20 by executing the firmware stored in the non-volatile memory 203. For example, the main processor 201 executes a virtual-physical configuration management process 201a and a firmware management process 201b, as well as various resident processes 201c, by executing firmware.

The virtual-physical configuration management process 201a is a process for constructing (defining) a virtual target VT, a virtual initiator VI-2, and a virtual volume VVOL.

Here, the virtual target VT is an interface for communicating with the virtual initiator VI-1 in the base switch 10, and is adapted to receive an instruction (command) sent from the virtual initiator VI-1 in the base switch 10.

The virtual initiator VI-2 is an interface for accessing an arbitrary storage apparatus (for example, the storage 80) within the fabric F accommodating the proxy switch (hereinafter, referred to as “supporting fabric”).

The virtual volume VVOL is a virtual volume defined in the proxy switch 20. The virtual-physical configuration management process 201a allocates a storage area from an arbitrary volume space in the storage 80 within the supporting fabric F to the virtual volume VVOL.

Data in the virtual volume VVOL can be read or written, from the virtual initiator VI-1 in the base switch 10 via the virtual target VT in the proxy switch 20. Furthermore, data in the virtual volume VVOL can be directly read and written from the proxy switch 20 without bypassing the base switch 10.

The virtual volume VVOL in the proxy switch 20 defines relations to a physical volume within the storage 80. Since the proxy switch 20 is aware of firmware data stored within the virtual volume VVOL, a read or write instruction to the virtual volume causes accesses to a related physical volume for reading or writing data stored in that physical volume.

Note that any accesses to physical volumes are made by way of the virtual initiator VI-2. From the viewpoint of the storage 80, such accesses appear as accesses from a virtual server, i.e., the virtual initiator VI-2.

The virtual initiator VI-2 and the virtual target VT are used by the base switch 10 and the proxy switch 20 to access the storage 80 for reading and writing firmware data.

The firmware management process 201b is a process for managing firmware in each switch 60 in the supporting fabric F. More specifically, the firmware management process 201b manages information (version or the like) of firmware installed in each switch 60, using the firmware management table set TS.

The firmware management table set TS includes two firmware management tables T1 and T2, as depicted in FIG. 1.

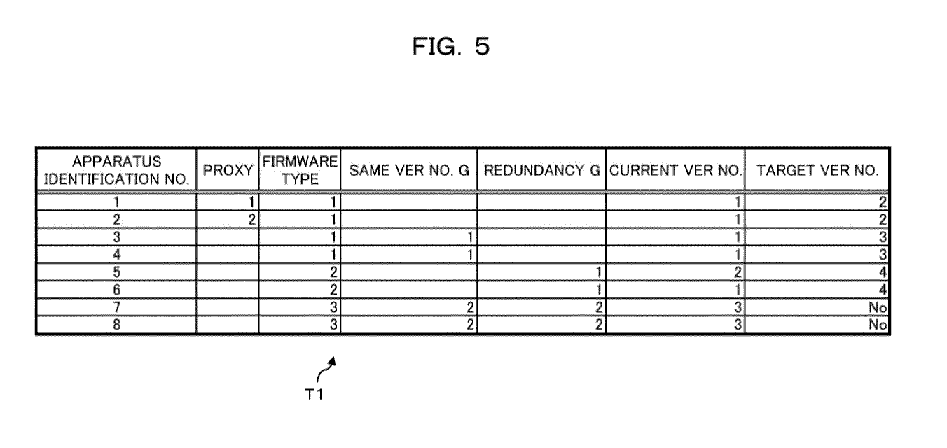

FIG. 5 is a diagram illustrating an example of the firmware management table T1, and FIG. 6 is a diagram illustrating an example of the firmware management table T2.

The firmware management table T1 maintains information regarding firmware in switches 60 in a fabric F, and includes fields (parameters) of an apparatus identification number (APPARATUS IDENTIFICATION NO.), a proxy (PROXY), a firmware type (FIRMWARE TYPE), a same version number group (hereinafter, group may be referred to as “G”) (SAME VER NO. G), a redundancy G (REDUNDANCY G), a current version number (CURRENT VER NO.), and a target version number (TARGET VER NO.), as depicted in FIG. 5.

The “APPARATUS IDENTIFICATION NO.” is identification information uniquely assigned to each apparatus to which firmware is to be applied (firmware application target apparatus; switch 60). In the example depicted in FIG. 5, eight switches 60 are provided in a fabric F identified by fabric number=1, and integers of 1-8 are assigned to these eight switches 60 as apparatus identification numbers.

Note that the fabric numbers are identification information uniquely assigned to the respective fabrics F.

The “PROXY” indicates an apparatus that receives firmware application instructions from a basement server, and “1” is set to an apparatus to be a master and “2” is set to an apparatus to be a slave.

The “FIRMWARE TYPE” is identification information representing a type of firmware, and three types of firmware identified by integers of 1, 2, and 3 are illustrated in FIG. 5.

The “SAME VER NO. G” is information indicating switches (apparatus group) to which the same version of firmware is to be applied, and the same numerical value is set to a plurality of switches 60 to which the same version of firmware is to be applied. For example, in the example depicted in FIG. 5, the same version number G=1 is set to switches 60 having apparatus identification numbers 3 and 4, and the same version number G=2 is set to switches 60 having apparatus identification numbers 7 and 8. Accordingly, it is indicated in this example that firmware with the same version number is to be applied to the switch 60 having an apparatus identification number of 3 and the switch 60 having an apparatus identification number of 4. Similarly, it is indicated in this example that firmware with the same version number is to be applied to the switch 60 having an apparatus identification number of 7 and the switch 60 having an apparatus identification number of 8.

The “redundancy G” is information indicating switches 60 (apparatus group) that forms a redundancy path, and a numerical value is set to each of a plurality of switches 60 making the redundancy path. That is, in this redundancy G, an identifier identifying a group making up the same path is stored. For example, in the example depicted in FIG. 5, the redundancy G=1 is set to switches 60 having apparatus identification numbers 5 and 6, and the redundancy G=2 is set to switches 60 having apparatus identification numbers 7 and 8. Accordingly, it is indicated in this example that the switch 60 having an apparatus identification number of 5 and the switch 60 having an apparatus identification number of 6 are configured to form a redundancy path. Similarly, it is indicated in this example that the switch 60 having an apparatus identification number of 7 and the switch 60 having an apparatus identification number of 8 are configured to form a redundancy path.

The “CURRENT VER NO.” is the version number of firmware installed in the switch 60, and is obtained by sending, by the firmware management process 201b, a command requesting the version number to the switches 60, for example.

The “TARGET VER NO.” is information (version number) for specifying a desired version of firmware to be applied to the switch 60 (target version number).

Note that, among the information, the same version number G, the redundancy G, and the target version number are set by an operator or the like, as desired, using the management terminal 30 or the like, for example. The information entered through the management terminal 30 is sent to the base switch 10 that will be described later, and is then sent from the base switch 10 to the corresponding proxy switch 20.

The firmware management table T2 maintains information regarding firmware, and is requirement information representing a constraint condition that is to be met when modifying a version of firmware to another version, for each of a plurality of versions of the firmware. The requirement information is created by relating the step count information indicating the step count of version that can be directly changed to (skipping any intermediating step(s)), the step counted from a certain version, for each version of the firmware.

In the example depicted in FIG. 6, the respective pieces of firmware of firmware types 1, 3, and 4 have respective four versions of version numbers 1-4, and the piece of firmware of a firmware type 2 has five versions of version numbers 1-5. Note that, in the example depicted in FIG. 6, version information (version, revision) of each version number of firmware is preceded by “v” and is double-quoted (“). For example, the firmware of a firmware type 2 with a version number of 2 is denoted as “v4.4”.

Similarly, for example, pieces of firmware of a firmware type 3 with version numbers 1, 2, 3, and 4 are denoted by v5.3, v6.0, v6.1, and v6.1.2, respectively.

Furthermore, in the firmware management table T2, an U/D parameter is set, with being related to each version number of each firmware type. The U/D parameter is information indicating to which version of firmware can be directly at once changed when a certain version of firmware is upgraded or downgraded to an upper or lower version. That is, the U/D parameter is the firmware version number that can be directly changed to upon upgrading or downgrading (constraint step count).

In the example depicted in FIG. 6, constraint step count when upgrading are represented by the numbers at the left of the forward slash (/), and constraint step count when downgrading are represented by the numbers at the right of the forward slash (/).

For example, supposing when upgrading a certain version of firmware, the constraint step count “N” (N is a natural number) means that up to the version of firmware, that is N steps upper with respect to that certain version, can be directly changed, skipping N−1 steps. Similarly, supposing when downgrading a certain version of firmware, it means that down to the version of firmware, that is N steps lower with respect to that certain version, can be directly changed, skipping N−1 steps.

Accordingly, supposing when upgrading a certain version of firmware, the constraint step count=2 means that up to the version of firmware, that is two steps upper with respect to that certain version, can be directly changed, skipping one step. Similarly, supposing when downgrading a certain version of firmware, it means that down to the version of firmware, that is two steps lower with respect to that certain version, can be directly changed, skipping one step.

Furthermore, supposing when upgrading a certain version of firmware, the constraint step count=1 means that only the version of firmware, that is one step upper with respect to that certain version, can be applied. Similarly, supposing when downgrading a certain version of firmware, it means that only the version of firmware, that is one step lower with respect to that certain version, can be applied.

Note that constraint step count=0 means that the firmware can be upgraded or downgraded limitlessly. Furthermore, constraint step count=FFFF means that upgrading or downgrading is not allowed.

For example, in the example depicted in FIG. 6, for the firmware (version number 1) of v4.2 having a firmware type of 2, when upgrading, the version of firmware, that is one step upper with respect to that version, can be applied, and no downgrading is allowed when downgrading. Furthermore, for the firmware (version number 2) of v4.4 having a firmware type of 2, when upgrading, up to the version of firmware, that is two steps upper with respect to that version, can be directly changed, meaning that firmware of v5.0.1 or v5.0.2 can be applied. Furthermore, when downgrading, the version of firmware, that is one step upper (v4.2), can be applied.

Furthermore, the firmware of v5.0.2 having a firmware type of 2 (version number 4) is limitless upon upgrading. Furthermore, when downgrading, down to the version of firmware, that is two versions lower with respect to that version, can be directly changed, meaning that the firmware of v4.4 or v5.0.1 can be applied. Note that the column “NOTES” indicates various types of information relating to the firmware.

Note that the U/D parameters and notes in the firmware management table T2 can be set by an operator using the management terminal 30 or the like, for example. The information entered through the management terminal 30 is sent to the base switch 10 that will be described later, which sends it to a corresponding proxy switch 20.

These firmware management tables T1 and T2 are maintained in each fabric F. More specifically, each proxy switch 20 maintains firmware management tables T1 and T2 for its supporting fabric F as a firmware management table set TS.

As described above, in the proxy switch 20, by storing the firmware management table T1, the non-volatile memory 203 functions as a version information storage section that stores version information of respective firmware installed in the plurality of switches 60. Furthermore, by storing the firmware management table T2, the non-volatile memory 203 functions as a requirement information storage section that stores requirement information defining a requirement that is met, for each of the plurality of versions, when changing that version of firmware to another version.

Furthermore, the firmware management process 201b includes a function to replace, when updated firmware management table T1 and/or T2 are sent from the base switch 10 that will be described later, the firmware management tables T1 and T2 stored in the non-volatile memory 203 with the updated firmware management tables T1 and T2.

Furthermore, upon changing the firmware of the switches 60, the firmware management process 201b selects version(s) of firmware to be installed in order to change the current version of firmware to a desired version, by looking up the firmware management table T1 and the firmware management table T2.

For example, for a switch 60 for which firmware change is instructed, the firmware management process 201b obtains the count of the step(s) from the current version number to the target version number by looking up the firmware management table T1. Furthermore, the firmware management process 201b obtains the constraint step count for the current version number of firmware by looking up the firmware management table T2 on the basis of the current version number.

Based on the information, the firmware management process 201b determines whether or not the desired version of firmware (the version, application of which is instructed) can be applied directly in order to change the firmware from the current version to the desired version.

That is, the firmware management process 201b implements a function as a confirmation section 210 (see FIG. 1) that checks, for a target version number of firmware, whether the target version number of firmware can be applied to the target switch 60 by looking up the firmware management tables T1 and T2 stored in the non-volatile memory 203.

Furthermore, when it is determined by the confirmation section 210 that the target version number of firmware cannot be directly applied to the target switch 60, the firmware management process 201b implements a function as a selection section 211 (see FIG. 1) that selects firmware to be installed to the target switch 60 from a plurality of versions of firmware by looking up the firmware management tables T1 and T2.

Note that hereinafter, a switch 60, for which firmware change is instructed, may be referred to as a “target switch 60”, and the firmware version number, application of which is instructed for the target switch 60, may be referred to as “target version number”.

Furthermore, when the target version number of firmware cannot be applied directly for changing the current version number to the target version number firmware, the firmware management process 201b (selection section 211) selects a version number of firmware (intermediate firmware) between the current version number and the target version number for installation.

Note that, when the target version number cannot be applied from the selected intermediate version of firmware, the firmware management process 201b further selects another intermediate version number of firmware between the selected intermediate version number of firmware and the target version number for installation.

That is, the firmware management process 201b changes the current version number to the target version number stepwise by selecting and installing at least one intermediate versions of firmware one by one when necessary.

In selecting intermediate firmware, when multiple versions are applicable to the current version number, it is desired to select a version number of firmware that is closest to the target version number among these versions, for example. This can help to effectively reduce the number of intermediate firmware versions to be applied.

That is, the firmware management process 201b implements a selection function that selects, for a target version number of firmware, firmware version(s) to be installed to a switch 60 among a plurality of versions of firmware by looking up version information (current version number, target version number) in the firmware management table T1 and the firmware management table T2.

When selecting intermediate firmware or installing it to a switch 60, the firmware management process 201b may prompt an operator to provide a permission for executing installation to the switch 60, using the management terminal 30 and the like. Furthermore, when intermediate firmware or the target version number of firmware is installed to the switch 60, the firmware management process 201b updates the firmware management table T1 stored in the non-volatile memory 203 where appropriate.

Furthermore, the firmware management process 201b sends the firmware management table set TS to the base switch 10 through the FC interface 204.

Furthermore, the firmware management process 201b controls to obtain firmware to be installed to the switches 60 in its supporting fabric F from the base switch 10 and to store the obtained firmware in the storage 80.

The firmware management process 201b also implements an install processing function that installs firmware that is selected in the manner as described above to a target switch 60.

In response to receiving a firmware change instruction (firmware upgrade instruction) from the base switch 10 that will be described later, the firmware management process 201b controls to install firmware stored in the storage 80 (installation operation).

That is, the firmware management process 201b functions as an install processing section 212 (see FIG. 1) that installs firmware which is determined as applicable by the confirmation section 210 to a switch 60.

The install processing section 212 is adapted to install firmware selected by the selection section 211 to a target switch 60, and installs the firmware by outputting a command for installing the firmware to the switch 60, for example.

The specific techniques for installing firmware to the switches 60 may be implemented using well-known various techniques.

For example, a proxy switch 20 connects to a switch 60 through a telnet command or the like, and issues a command for installing firmware stored in the storage 80 to the switch 60. For example, the install processing section 212 logs in to a target switch 60 using a function, such as Telnet, and outputs a command (for example, firmware download) for installing the firmware, together with specifying a storage location of the firmware (storage location in the storage 80) to commence the installation. As the command for installing the firmware, well-known various commands may be employed.

Furthermore, the firmware management process 201b includes a function to check whether or not communication with each switch 60 is available through the Ethernet interface 205 using the polling function of the Ethernet standard, i.e., a function to monitor the active status of each switch 60. Furthermore, the active status monitor function also obtains version numbers of firmware installed in the respective switches 60, and compares them with the current version number recorded in the firmware management table T1. This active status monitor function is performed regularly or at predetermined non-regular timing.

When an obtainment request for version numbers of firmware of the active switches 60 is made from the virtual initiator VI-1 in the base switch 10 that will be described later, the virtual target VT in the proxy switch 20 receives this obtainment request.

The obtainment request received by the virtual target VT is passed to the firmware management process 201b in the proxy switch 20, and the above-described active status monitor function of the firmware management process 201b obtains firmware information of all of the switches 60 connected to the proxy switch 20.

Once obtaining firmware version numbers of the respective switches 60, the firmware management process 201b records the firmware version numbers of the respective switches 20 to the “CURRENT VER NO.” field in the firmware management table T1 stored in the non-volatile memory 203. The firmware management process 201b then sends a reply to the virtual initiator VI-1 in the base switch 10, attaching the firmware management table T1.

Furthermore, for example, when a switch 60 being connected to the Ethernet interface 205 is detected, the version number of firmware installed in that switch 60 is compared against the current version number recorded in the firmware management table T1 in the proxy switch 20.

For example, a switch 60 is swapped with a new one and the new switch 60 is connected to the proxy switch 20, the firmware management process 201b obtains the version number of firmware that has been installed in the new switch 60, and compares it with the current version number recorded in the firmware management table T1.

When the version number of firmware that has been installed in the new switch 60 is different from the current version number recorded in the firmware management table T1, the firmware management process 201b applies, to that switch 60, the same version number of firmware as the current version number recorded in the firmware management table T1 for that switch 60.

For example, the new switch 60 has a newer version of firmware than that of the previous switch 60, the firmware management process 201b obtains the version number of firmware that is the same as the current version number recorded in the firmware management table T1 from the storage 80, and installs it to (downgrades) the new switch 60.

Upon downgrading, the firmware management process 201b determines whether this downgrading from the version number of firmware of the new switch 60 to the target version number of firmware (target version number) satisfies the constraint condition by looking up the firmware management table T2.

When the constraint condition is not met, i.e., when the target version number of firmware cannot be applied directly (cannot be directly changed to), the firmware management process 201b downgrades to the target version number of firmware after installing any intermediate firmware.

Resident processes 201c are processes routinely executed by the main processor 201. The resident processes 201c monitor the status of the storage 80 connected through the FC interface 204, manage the communication status with the base switch 10, or notify the management terminal 30 that will be described later of an error when some abnormality is detected during the monitoring, for example. Furthermore, the main processor 201 performs various settings, protocol controls, and the like, as the resident processes 201c. Note that these functions are known as general functions (resident processes) of switches, and the detailed description thereof will be omitted.

The main processor 201 in the proxy switch 20 functions as the firmware management process 201b (the confirmation section 210, the selection section 211, the install processing section 212), the virtual-physical configuration management process 201a, and the resident processes 201c as described above, by executing firmware (management programs).

Note that management programs for implementing the functions as the firmware management process 201b, the virtual-physical configuration management process 201a, and the resident processes 201c are provided in the form of programs recorded on a computer readable recording medium, such as, for example, a flexible disk, a CD (e.g., CD-ROM, CD-R, CD-RW), a DVD (e.g., DVD-ROM, DVD-RAM, DVD-R, DVD+R, DVD-RW, DVD+RW, HD DVD), a Blu Ray disk, a magnetic disk, an optical disk, a magneto-optical disk, or the like. The computer then reads a program from that storage medium and uses that program after transferring it to the internal storage apparatus or external storage apparatus or the like. Alternatively, the program may be recoded on a storage device (storage medium), for example, a magnetic disk, an optical disk, a magneto-optical disk, or the like, and the program may be provided from the storage device to the computer through a communication path.

When implementing functions as the firmware management process 201b, the virtual-physical configuration management process 201a, and resident processes 201c, programs stored in internal storage devices (the non-volatile memory 203, in this embodiment) are executed by a microprocessor in a computer (the main processor 101, in this embodiment). In this case, the computer may alternatively read a program stored in the storage medium for executing it.

Note that, in this embodiment, the term “computer” may be a concept including hardware and an operating system, and may refer to hardware that operates under the control of the operating system. Alternatively, when an application program alone can make the hardware to be operated without requiring an operating system, the hardware itself may represent a computer. The hardware includes at least a microprocessor, e.g., CPU (central processing unit), and means for reading a computer program recorded on a storage medium and, in this embodiment, the proxy switches 20 and the base switch 10 include functions as a computer.

The firmware server 40 is adapted to manage and store firmware used in the respective switch 60 provided in the storage system 100, and is configured as an information processing apparatus including a display, input devices, a CPU, a memory, and the like, which are not illustrated. The firmware server 40 is configured as a server computer including the storage 41, for example, and saves, in the storage 41, all versions of firmware for all of the switches 60 provided in the storage system 1.

The firmware server 40 is connected to the base switch 10 through the communication link 502, and, in response to a request from the base switch 10 (firmware obtainment request), sends the requested version of firmware to the base switch 10.

Furthermore, a new version of firmware is generated for the switches 60, that new version of firmware is stored in the storage 41, together with older versions of firmware, and is managed by the firmware server 40.

Note that registration of the new version of firmware to the firmware server 40 is made when data of the new firmware is sent from the management terminal 30 to the firmware server 40, for example.

The management terminal 30 is an information processing apparatus used by an operator, and is configured as an information processing apparatus including a display, input devices, a CPU, a memory, and the like, which are not illustrated.

The operator manages firmware in the respective switches 60 in the storage system 100 using the management terminal 30. More specifically, the operator enters information, such as “SAME VER NO. G”, “REDUNDANCY G”, “TARGET VER NO.”, regarding a certain switch 60, to be recorded to the firmware management table T1, using input devices, such as a keyboard and a mouse. Furthermore, when new firmware is created, the operator enters information (U/D parameters or notes) regarding the new firmware, to be recorded to the firmware management table T2.

The information entered via the input devices of the management terminal 30 is sent to the base switch 10 through the communication link 503 and/or the LAN/WAN 507.

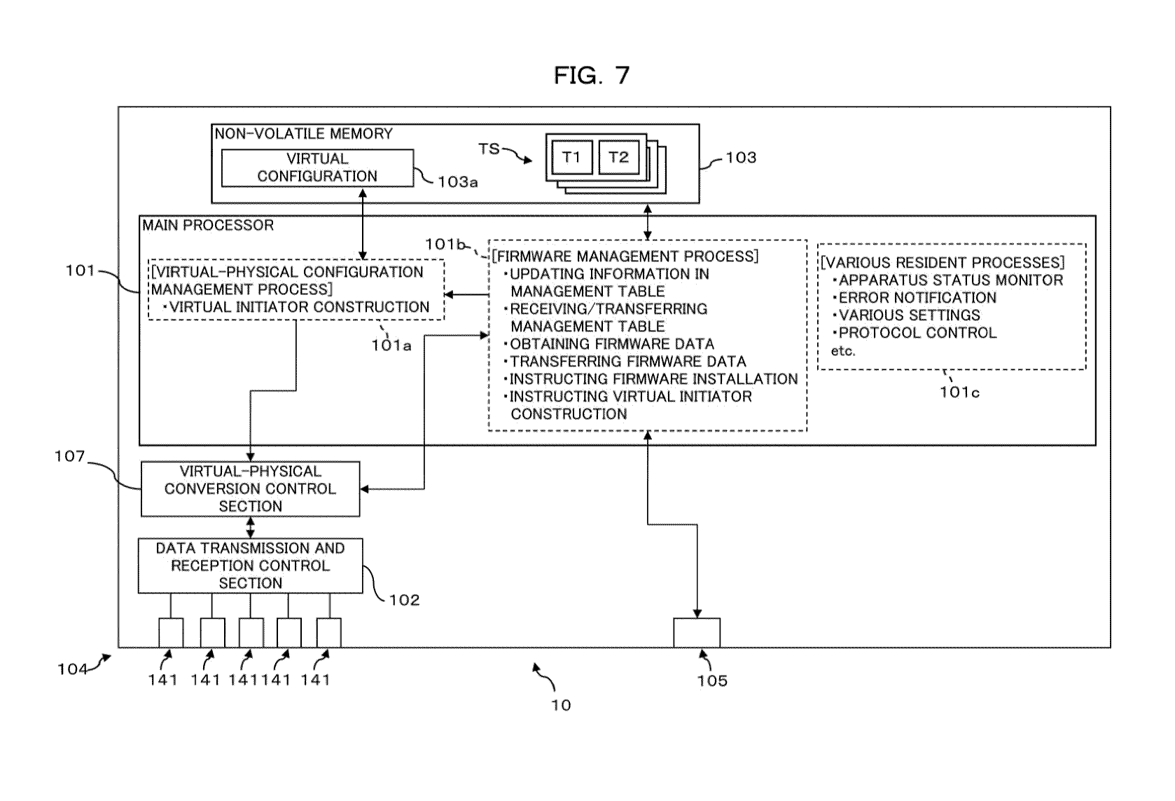

FIG. 7 is a diagram schematically illustrating an example of the configuration of the base switch in this management system.

The base switch 10 is communicatively connected to each of the proxy switches 20, the firmware server 40, and the management terminal 30 in the storage system 100, and a single base switch 10 is provided in the storage system 100.

The base switch 10 is configured to include, as depicted in FIG. 7, a main processor 101, a data transmission and reception control section 102, a non-volatile memory 103, an FC interface 104, an Ethernet interface 105, and a virtual-physical conversion control section 107.

Similar to the FC interface 204 in a proxy switch 20, the FC interface 104 is an interface through which FC-compliant appliances are connected, and is configured to include a plurality of (five, in the example depicted in FIG. 7) ports 141. The ports 141 are connected to the proxy switches 20 through the communication links 501, for example.

The data transmission and reception control section 102 is adapted to implement data transmission and reception processing to and from the proxy switch 20 connected to the FC interface 104.

The Ethernet interface 105 is an interface through which Ethernet-compliant appliances are connected. The base switch 10 is connected to the communication link 502 through the Ethernet interface 105, and is connected to the management terminal 30 and the firmware server 40 through the communication links 502 and 503 and the LAN/WAN 507. Note that although the management terminal 30 and the firmware server 40 are depicted to being connected to the base switch 10 through the LAN/WAN 507 in the example depicted in FIG. 2, the connections between the Ethernet interface 105 and these devices may be practices in various manners.

The base switch 10 can receive various types of information to be recorded to the firmware management tables T1 and T2 from the management terminal 30 through the communication links 502 and 503 and the LAN/WAN 507, and receives firmware from the firmware server 40. Note that functions controlled on the base switch 10 are manipulated from the management terminal 30.

The non-volatile memory 103 is a storage area wherein various pieces of data and programs are stored. Virtual configuration information 103a and a firmware management table set TS are stored in the non-volatile memory 103. Here, the virtual configuration information 103a is information used by the main processor 101 that will be described later when executing virtual-physical configuration management process 101a. Furthermore, the firmware management table set TS is information used by the main processor 101 when executing the firmware management process 101b.

The firmware management table set TS is sent from each of the connected proxy switches 20 to the base switch 10, and the received firmware management table set TS is stored in the non-volatile memory 103 in the base switch 10. Respective firmware management table sets TS are maintained for each of the fabrics F in the base switch 10.

In other words, the base switch 10 includes management tables managing firmware information of the switches 60 in all fabrics F.

Furthermore, the non-volatile memory 103 also stores firmware (program) for implementing various functions of the base switch 10.

The virtual-physical conversion control section 107 is adapted to transfer a request from the firmware management process 101b that will be described later to a data transmission and reception control section 102 (FC interface 104). Note that functions as the virtual-physical conversion control section 107 can be implemented by known techniques, and are configured as a large scale integrations (LSI), for example.

The main processor 101 is adapted to implement various controls and functions of the base switch 10 by executing the firmware stored in the non-volatile memory 103. For example, the main processor 101 executes the virtual-physical configuration management process 101a and the firmware management process 101b, as well as various resident processes 101c, by executing firmware.

The virtual-physical configuration management process 101a defines and establishes a virtual initiator VI-1 and enables communication with the proxy switches 20 with this virtual initiator VI-1.

The virtual-physical configuration management process 101a defines a virtual initiator VI-1 for a proxy switch 20 in the respective fabrics F.

The virtual-physical configuration management process 101a reserves an arbitrary volume in a certain storage (the storage 80, in this embodiment) in the same fabric F, and allocates a virtual volume VVOL on the proxy switch 20 for storing firmware. Furthermore, the virtual-physical configuration management process 101a defines a virtual target VT that can communicate with the virtual initiator VI-1 in the base switch 10. Accesses from the base switch 10 to the virtual volume VVOL is enabled by coupling the virtual target VT and the virtual volume VVOL described previously.

The firmware management process 101b is a process for managing firmware in the switches 60 in the respective fabrics F in the storage system 100. The firmware management process 101b also instructs the above-described virtual-physical configuration management process 101a to construct a virtual initiator VI-1 (virtual initiator construction instruction).

The firmware management process 101b also obtains version numbers of firmware in the active switches 60 in the storage system 100.

More specifically, the virtual initiator VI-1 in the base switch 10 requests the virtual targets VT in the proxy switches 20 to notify firmware version numbers of all of the switches 60 connected to the respective fabrics F.

Furthermore, the firmware management process 101b identifies version numbers of all of the switches 60 from information in the firmware management tables T1 obtained from each proxy switch 20, and downloads firmware data of these version numbers from the firmware server 40. The downloaded firmware data is transferred to the respective virtual volumes VVOL in the proxy switches 20 via the virtual initiator VI-1 in the base switch 10.

The firmware management process 101b manages information (versions or the like) of firmware installed in the respective switch 60, using the firmware management table set TS.

When an entry is made on the management terminal 30 for updating information recorded in the firmware management tables T1 and T2, the firmware management process 101b updates the firmware management table set TS stored in the non-volatile memory 103 according to the supplied information (management table update).

When the firmware management table T1 is updated by an entry made on the management terminal 30, the firmware management process 101b checks whether the updated firmware management table T1 includes any new version number that is not listed in the previous firmware management table T1. When any new version number of firmware is found in the updated firmware management table T1, the firmware management process 101b downloads the new version of firmware from the firmware server 40 (firmware data obtainment).

The firmware management process 101b then transfers the downloaded firmware to the proxy server 20 in the fabric F corresponding to the updated firmware management table T1 (firmware data transfer) for storing into its storage 80.

In this step, the firmware management process 101b also sends the updated firmware management tables T1 and T2 to the proxy switch 20 in the corresponding fabric F. The firmware management process 101b makes that proxy switch 20 to replace the firmware management tables T1 and T2 stored in the non-volatile memory 203 with the firmware management tables T1 and T2 that are sent (firmware application instruction).

More specifically, the firmware management process 101b instructs application of the new firmware from the virtual initiator VI-1 in the base switch 10 to the virtual target VT in the proxy switch 20 in the respective fabrics F.

Furthermore, the firmware management process 101b includes a function to receive the firmware management table set TS sent from a proxy switch 20 (management table reception), and to replace the firmware management table set TS stored in the non-volatile memory 103 with the received firmware management table set TS.

The main processor 101 in the base switch 10 functions as the firmware management process 101b, the virtual-physical configuration management process 101a, and resident process 101c that are described above, by executing firmware (program).

Note that the programs for implementing the functions as the virtual-physical configuration management process 101a, the firmware management process 101b, and resident process 101c are provided in the form of record in a computer readable recording medium, such as a flexible disk, CD, DVD, Blu Ray disk, magnetic disk, optical disk, opto-magnetic disk.

When implementing functions as the firmware management process 101b, the virtual-physical configuration management process 101a, and resident processes 101c, programs stored in internal storage devices (the non-volatile memory 103 in this embodiment) are executed by a microprocessor in a computer (the main processor 101, in this embodiment). In this case, the computer may alternatively read a program stored in the storage medium for executing it.

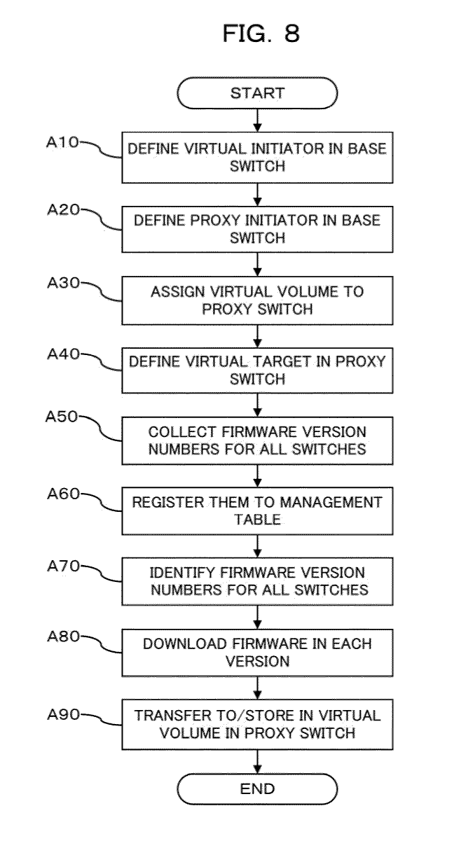

One example of the operational procedure of a technique for managing and registering firmware in each switch 60 in the management system 1 constructed as above now will be described with reference to the flowchart depicted in FIG. 8 (Steps A10-A90).

Using the management terminal 30, an operator instructs the base switch 10 to obtain firmware version number information of all of the switches 60 being managed in order to obtain version numbers of firmware of the active switches 60 in the storage system 100. In response, in the base switch 10, the firmware management process 101b makes a virtual initiator construction instruction to the virtual-physical configuration management process 101a.

In response to this virtual initiator construction instruction, the virtual-physical configuration management process 101a defines a virtual initiator VI-1 on the base switch (Step A10).

The virtual-physical configuration management process 101a defines a virtual initiator VI-1 for a proxy switch 20 in the respective fabrics F (Step A20). The virtual-physical configuration management process 101a also reserves an arbitrary volume in the storage 80 in the same fabric F, and allocates a virtual volume VVOL on the proxy switch 20 for storing firmware.

Furthermore, the virtual-physical configuration management process 101a defines a virtual target VT that can communicate with the virtual initiator VI-1 in the base switch 10. Accesses from the base switch 10 to the virtual volume VVOL is enabled by coupling the virtual target VT and the virtual volume VVOL described previously.

The virtual initiator VI-1 in the base switch 10 requests the virtual targets VT in the proxy switches 20 to notify firmware version numbers of all of the switches 60 connected to the respective fabrics F (Step A50).

Each proxy switch 20 passes the notification request for firmware version numbers received by the virtual target VT to the firmware management process 201b in that proxy switch 20, and obtains firmware information of all of the switches 60 connected to that proxy switch 20. After obtaining firmware version numbers, the firmware management process 201b records the firmware version numbers of all of the switches 60 to the firmware management table set TS (Step A60). At this stage, not all of the parameters in the firmware management table set TS are supplied. The firmware management process 201b sends a reply to the virtual initiator VI-1 in the base switch 10, attaching the firmware management table set TS.

The base switch 10 identifies version numbers of all of the switches 60 from information in the firmware management table set TS obtained from each proxy switch 20 (Step A70), and downloads firmware data of these version numbers from the firmware server 40 (Step A80).

The firmware data is transferred to the respective virtual volumes VVOL in the proxy switches 20 via the virtual initiator VI-1 in the base switch 10 (Step A90). In this manner, data of all versions of firmware installed in the switches 60 in the same fabric F is stored in the virtual volume VVOL in each proxy switch (the storage 80).

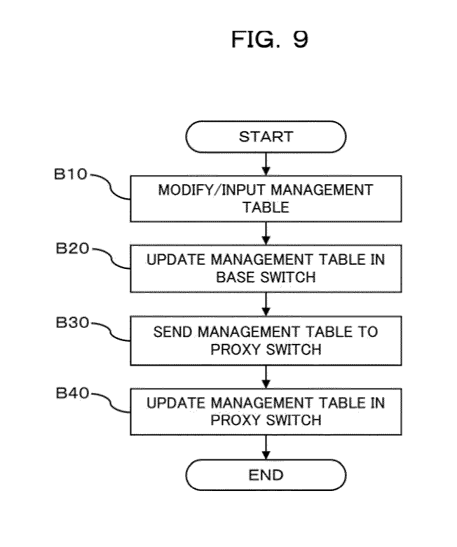

Next, a technique for updating a firmware management table TS in the management system 1 will be described with reference to a flowchart (Steps B10-B40) illustrated in FIG. 9.

Using the operator terminal 30, an operator updates information in firmware management tables T1 and T2 according to the system configuration of each fabric F and operation conditions (Step B10).

More specifically, the operator modifies the values of “PROXY”, “FIRM TYPE”, “SAME VER NO. G”, “REDUNDANCY G” (parameters) in a firmware management table T1 according to requirements. Initially, the modification to the firmware management table T1 made by the operator is reflected to the firmware management table set TS (firmware management table T1) stored in the non-volatile memory 103 in the base switch 10.

After the firmware management table TS is updated in the base switch 10 (Step B20), the updated firmware management tables T1 and T2 are sent from the base switch 10 to the proxy switches 20 in the respective fabrics F (Step B30). Thereafter, in each proxy switch 20, the firmware management table set TS stored in the non-volatile memory 203 is replaced with the firmware management table set TS that is sent (Step B40).

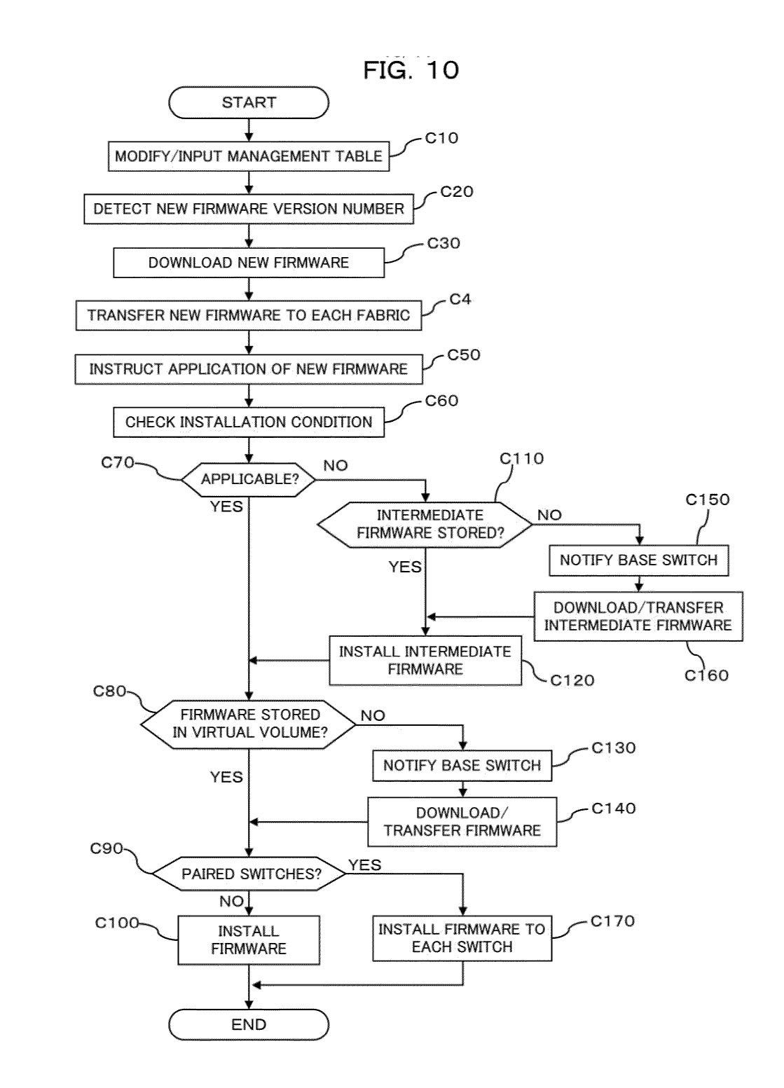

Next, a technique for changing firmware in a switch 60 in the management system will be described with reference to a flowchart (Steps C10-C170) illustrated in FIG. 10.

An operator updates information in firmware management tables T1 and T2 in the base switch 10 by making entry on the management terminal 30 (Step C10). More specifically, the operator initially adds, to the firmware management table T2, requirement information (U/D parameter) for new firmware to be applied. The operator also specifies, for a switch 60 for changing its firmware, a firmware version number to be applied to the “TARGET VER NO.” parameter in the firmware management table T1.

In the base switch 10, the firmware management process 101b monitors the firmware management tables T1 and T2. When the process finds a new firmware version number in the firmware management tables T1 and T2 (Step C20), it downloads the master data of that new version number of firmware from the firmware server 40 (Step C30). The firmware management process 101b also transfers the downloaded firmware data to virtual volumes VVOL in the respective fabrics F (Step C40).

Furthermore, an application instruction for the new firmware is sent from the virtual initiator VI-1 in the base switch 10 to the virtual target VT in the proxy switch 20 in each of the fabrics F including target switch(es) 60 (Step C50). In this step, the firmware management tables T1 and T2 that were updated in Step C10 are also sent.

Upon receiving the firmware application instruction, a proxy switch 20 checks installation conditions by looking up the firmware management tables T1 and T2 that are sent (Step C60). That is, the firmware management process 201b obtains the version number of firmware currently installed in the target switch 60 (current version number) from the firmware management table T1. The firmware management process 201b also obtains the U/D parameter by looking up the firmware management table T2 based on the obtained current version number.

The firmware management process 201b then determines whether or not the target version number of firmware can be applied to the target switch 60 based on the current version number, the U/D parameter, and the target version number (Step C70; confirmation step).

When the target version number of firmware can be applied to the target switch 60 (see the YES route in Step C70), the firmware management process 201b then checks whether or not the corresponding firmware data is stored in the virtual volume VVOL (Step C80).

When data of the target version number of firmware is stored in the virtual volume VVOL (see the YES route in Step C80), the firmware management process 201b obtains the firmware data and installs it to the target switch 60.

In this step, the firmware management process 201b also checks whether or not the switch 60 is in a paired configuration by looking up the firmware management table T1 (Step C90). When the target switch 60 is not in a paired configuration, i.e., when no redundant apparatus group is registered in the “REDUNDANCY G” parameter in the firmware management table T1 (see the NO route in Step C90), the target version number of firmware is installed only to the target switch 60 (Step C100; installation step) and terminates the processing.

Otherwise, when the target switch 60 is in a paired configuration (see the YES route in Step C90), the target version number of firmware is installed to each of the switches 60 constructing a paired configuration one by one (Step C170; installation step). When installing the firmware to multiple switches 60 constructing the paired configuration, in addition to installing the firmware to each switch one after another. In this process, the firmware can be installed to a next switch 60 only after confirming that the previous switch 60 returns online after installation of the firmware. Thereby, installation to all of the switches 60 can be done without suspending the system. After the firmware management process 201b completes installing the firmware to all of the switches 60 constructing the paired configuration, the processing is terminated.

Otherwise, when data of the target version number of firmware is not stored in the virtual volume VVOL (see the NO route in Step C80), the firmware management process 201b notifies (replies to) the virtual initiator IV-1 in the base switch 10 (Step C130) of (about) this. In this step, the firmware management process 201b also notifies the desired target version number of firmware.

In response to the reply from the virtual initiator VI-2 in the proxy switch 60, in the base switch 10, the firmware management process 101b downloads data of the target version number of firmware from the firmware server 40. Furthermore, the base switch 10 sends the downloaded firmware data of the target version number to that proxy switch 60 (Step C140). Upon receiving the firmware data from the base switch 10, the proxy switch 20 stores the received firmware data in the virtual volume VVOL, and the flow moves to Step C90.

Furthermore, when the target version number of firmware cannot be applied to (is not compatible with) the target switch (see the NO route in Step C70), the firmware management process 201b checks whether or not any intermediate firmware is stored in the virtual volume VVOL, which can be used for changing the firmware from the current version number to the target version number (Step C110; selection step).

When such an intermediate number of firmware data is stored in the virtual volume VVOL (see the YES route in Step C110), the firmware management process 201b obtains the data of the intermediate firmware and installs it to the target switch 60 (Step C120; installation step).

Otherwise, when such intermediate firmware is not stored in the virtual volume VVOL (see the NO route in Step C110), the firmware management process 201b notifies the virtual initiator IV-1 in the base switch 10 of this (Step C150). In this step, the firmware management process 201b also notifies information for identifying the desired intermediate firmware.

In response to the reply from the virtual initiator in the proxy switch 60, in the base switch 10, the firmware management process 101b downloads data of the specified intermediate firmware from the firmware server 40. Furthermore, the base switch 10 sends the downloaded data of the intermediate firmware to that proxy switch 60 (Step C160), and the flow goes to Step C120. That is, multiple steps of firmware are automatically installed by means of any intermediate firmware, if necessary.

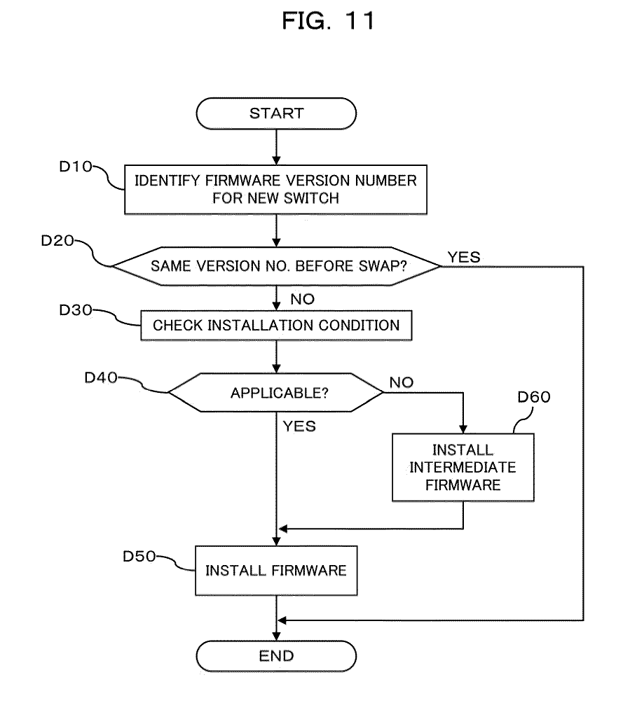

Next, processing for swapping switches 60 in the management system 1 will be described with reference to a flowchart (Steps D10-D60) illustrated in FIG. 11.

When switches 60 are swapped by a maintenance engineer due to failure, a proxy switch 20 identifies a firmware version number of a new switch 60 when the new switch 60 is connected to the proxy switch 20 (Step D10). More specifically, the firmware management process 201b in the proxy switch 20 checks whether or not the firmware version number in the new switch 60 is the same as the firmware version number in the previous switch 60 (Step D20).

This check can be made by comparing the firmware version number obtained from the new switch 60 with the firmware version number recorded in the firmware management table T1 for the previous switch 60, for example.

When the firmware version number in the new switch 60 does not match the firmware version number in the previous switch 60 (see the NO route in Step D20), the version number of firmware of the previous switch 60, which is well-approved, is applied to the new switch 60 (target switch).

For this purpose, the firmware management process 201b obtains the U/D parameter for change from the firmware version number in the new switch 60 to the firmware version number in the previous switch 60 (target version number) by looking up the firmware management table T2. That is, the firmware management process 201b checks the install conditions (Step D30).

The firmware management process 201b then determines whether or not the target version number of firmware can be applied to the target switch 60, based on the current version number, the U/D parameter, and the target version number (Step D40).

When the target version number of firmware can be applied to the target switch 60 (see the YES route in Step D40), the firmware management process 201b installs the target version number of firmware to the target switch 60 using firmware data stored in the virtual volume VVOL (Step D50) and terminates the processing.

Otherwise, when the target version number of firmware cannot be applied to the target switch 60 (see the NO route in Step D40), the firmware management process 201b installs any intermediate firmware to the target switch 60 (Step D60) before going to Step D50.

Upon installing the intermediate firmware, the same processing as the above-described Steps C110, C120, C150, and C160 in FIG. 10 is desirable.

As described above, according to the storage system 100 as one example of this embodiment, when an operator supplies a firmware application instruction and updates a firmware management table T1 using the management terminal 30, the proxy switch 20 in the corresponding fabric F changes firmware in the target switch 60. This facilitates maintenance of firmware for the switches 60, which is convenient, and can reduce the management and operation costs. Furthermore, the availability of the system can be improved.

During the processing, the firmware management process 201b determines whether or not a target version number of firmware can be applied to a target switch 60, and any intermediate firmware is installed to the target switch 60 when the target version number of firmware cannot be applied to the target switch 60. This allows the target version number of firmware to be applied to the target switch 60. Furthermore, since the firmware management process 201b automatically selects and installs intermediate firmware to be applied, the work load of the operator can be reduced, which is highly convenient.

Furthermore, by maintaining firmware management tables T1 and T2 for each fabric F in the base switch 10 in a centralized manner, firmware management tables T1 and T2 can be easily edited and modified from the management terminal 30.

Furthermore, in response to any modification of firmware management tables T1 and T2 maintained in the base switch 10, the base switch 10 sends the modified firmware management tables T1 and T2 to the proxy switch 20 in the corresponding fabric F. Furthermore, in response to modification of a firmware management table T1 in a proxy switch 20, the modified firmware management table T1 is sent to the base switch 10. Since this can ensure that newest firmware management tables T1 and T2 are shared between the base switch 10 and the proxy switches 20, the reliability of the system can be improved.

Furthermore, when the switches 60 are swapped due to failure or the like, if the new switch 60 has a version number of firmware that is different from the previous switch 60, the version number of firmware before the swap is automatically installed. Since this can ensure that well-established firmware is installed to the switches 60, the reliability of the system can be improved.

Furthermore, during the swap, if the version of firmware before the swap cannot be directly applied to the new switch 60 for installing the version number before the swap to the new switch 60, any required intermediate firmware is automatically installed, which is highly convenient.

Furthermore, versions of firmware (including intermediate versions of firmware) used in switches 60 in a fabric F are stored in a virtual volume VVOL in its proxy switch 20. Thus, firmware is not needed to be obtained from the firmware server 40 when installing the firmware, which accelerates the installation, as well as alleviating the network traffic.

The disclosed technique is not limited to the embodiments described above, and various modifications may be made without departing from the spirit of the present embodiments.

For example, the base switch 10 and the proxy switch 20 may have the same configuration. More specifically, firmware for implementing the functions of the base switch 10 and firmware for implementing the functions of the proxy switches 20 are stored in hardware (non-volatile memories 103 or 203) of a switch that is to be the base switch 10 or a proxy switch 20. By selectively executing either firmware using a switch provided physically or provided by means of software, that switch is made to function as the base switch 10 or a proxy switch. By configuring the base switch 10 and the proxy switches in the same hardware in this manner, the system can be flexibly operated, which is highly convenient.

Similarly, in addition to firmware for implementing the functions of the switches 60, the firmware for implementing the functions of the base switch 10 and the firmware for implementing the functions of the proxy switches 20 may be stored in each of the switches 60. In other words, by selectively executing either firmware using a switch provided physically or by means of software, that switch is made to function as the base switch 10, a base switch, or a proxy switch. By configuring the switches 60, the base switch 10, and the proxy switches in the same hardware, the system can be flexibly operated, which is highly convenient.

Furthermore, although the constraint step counts upon upgrading and downgrading are set in the left and right sides of a forward slash in a U/D parameter in the embodiments described above, this is not limiting. For example, a constraint step count upon upgrading and a constraint step count upon downgrading may be maintained as separate fields related to each version number of firmware, and various modifications may be made without departing from the spirit of the present embodiments.

Furthermore, although firmware in the respective switches 60 is managed by the management system 1 in the embodiments described above, this is not limiting. For example, firmware in proxy switches 60 may be managed. Alternatively, firmware in other apparatuses than switches may be managed, or other programs than firmware may be managed.

Furthermore, in the embodiments described above, a proxy switch 20 and respective switches 60 are connected through communication links 506 compliant to the Ethernet standard, and it is not assumed that the proxy switch 20 does not configure the volumes of storages 72 using virtual volumes. However, this is not limiting, and these communication links 506 may be connected through any links compliant to the FC standard. Accesses to the storages 72 may be made from the proxy switch 20, and a virtual volume may be configured using the volumes of the storages 72. Thereby, since the proxy switch 20 and the switches 60 construct the same fabric, the proxy switch 20 can access to the volumes of the storages 72 and the storages 72 can be used for storing the firmware.

Although the switches 60 do not include the virtual function in the embodiments described above, this is not limiting. For example, by replacing the switches 60 with the proxy switches 20 having the same functions as the switches 60, the virtual function may be implemented by the proxy switches 20 used in place of the switches 60.

Although modified pieces of firmware have been referred to as “versions” in the above-described embodiments, this is non-limiting. For example, such modified pieces of firmware may be denoted using any suitable terms, such as revisions or any combination of versions and revisions.

The embodiments may be practiced or manufactured by those ordinarily skilled in the art with reference to the above disclosure.

The management system, the management apparatus, the management method, and the computer readable recording medium storing management program that are disclosed may provide at least one of the following advantageous effects or advantages:

(1) The maintenance of programs in data relay apparatuses is simplified, which is highly convenient.

(2) The management and operation cost of the system can be reduced.

(3) The availability of the system can be improved.

(4) The reliability of the system can be improved.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present disclosures have been described in detail, it should be understood that the various changes, substitutions, and alterations could be made hereto without departing from the spirit and scope of the invention.

What is claimed is:

1. A management system for managing, in a data transmission system to which a data relay apparatus is connected, a program for the data relay apparatus, comprising:
a program storage section that stores a plurality of versions of the program;
a version information storage section that stores version information on the program installed in the data relay apparatus;
a requirement information storage section that stores, for each of the plurality of versions of the program, requirement information for changing that version to a different version;
an instruction information entry section that receives version information of the version of the program to be applied to the data relay apparatus as instruction information;
a confirmation section that checks whether the version of the program instructed by the instruction information received through the instruction information entry section can be applicable to the data relay apparatus by looking up the version information stored in the version information storage section and the requirement information stored in the requirement information storage section; and
an install processing section that installs, in response to the confirmation section determining that the program is applicable, the program in the instructed version to the data relay apparatus.

2. The management system according to claim 1, further comprising a selection section that selects the program in another version applicable to the data relay apparatus on the basis of the requirement information, in response to the confirmation section determining that the program in the instructed version is not applicable,
wherein the install processing section installs the program in the instructed version after installing the version of the program selected by the selection section.

3. The management system according to claim 1, wherein order information indicating orders of the plurality of versions of the program is assigned to the program in each version, and
the requirement information includes the step count information related to each version of the program, the step count information indicating a count of at least one step that can be directly changed to, the step count being counted from the each version in accordance with the order.

4. The management system according to claim 1, further comprising:
a first management apparatus that is provided in each of at least one predetermined management region including a plurality of data relay apparatuses, and is communicatively connected to the plurality of data relay apparatuses in the management region;
a second management apparatus that is communicatively connected to the instruction information entry section and the at least one first management apparatus,
wherein the first management apparatus comprises the version information storage section, the requirement information storage section, the confirmation section, and the install processing section, and
the second management apparatus notifies the second management apparatus with the instruction information received through the instruction information entry section.

5. A management apparatus for managing, in a data transmission system to which a plurality of data relay apparatuses are connected, a program for the data relay apparatuses, comprising:
a version information storage section that stores respective version information on the program installed in each of the data relay apparatuses;
a requirement information storage section that stores, for each of the plurality of versions of the program, requirement information for changing that version to a different version;
a confirmation section that checks whether a version of the program application of which is instructed can be applicable to the data relay apparatuses by looking up the version information stored in the version information storage section and the requirement information stored in the requirement information storage section; and
an install processing section that installs, in response to the confirmation section determining that the program is applicable, the program in the instructed version to the data relay apparatuses.

6. The management apparatus according to claim 5, further comprising a selection section that selects the program in another version applicable to the data relay apparatuses on the basis of the requirement information, in response to the confirmation section determining that the program in the instructed version is not applicable,
wherein the install processing section installs the program in the instructed version after installing the version of the program selected by the selection section.

7. The management apparatus according to claim 5, wherein order information indicating orders of the plurality of versions of the program is assigned to the program in each version, and
the requirement information includes the step count information related to each version of the program, the step count information indicating a count of at least one step that can be directly changed to, the step count being counted from the each version in accordance with the order.

8. A management method for managing, in a data transmission system to which a plurality of data relay apparatuses are connected, a program for the data relay apparatuses, comprising:
a confirmation step that confirms, for a version of the program instructed by version information of the version of the program to be applied to the data relay apparatuses as instruction information, whether the version of the program can be applicable to the data relay apparatuses by looking up respective version information on the program installed in each of the data relay apparatuses and, for each of the plurality of versions of the program, requirement information for changing that version to a different version; and
an install processing step that installs, in response to the confirmation step determining that the program is applicable, the program in the instructed version to the data relay apparatuses.

9. The management method according to claim 8, further comprising a selection step that selects the program in another version applicable to the data relay apparatuses on the basis of the requirement information, in response to the confirmation step determining that the program in the instructed version is not applicable,
wherein the install processing step installs the program in the instructed version after installing the version of the program selected by the selection step.

10. The management method according to claim 8, wherein order information indicating orders of the plurality of versions of the program is assigned to the program in each version, and
the requirement information includes the step count information related to each version of the program, the step count information indicating a count of at least one step that can be directly changed to, the step count being counted from the each version in accordance with the order.

11. A computer readable recording medium recording a management program making a computer execute a management function for managing, in a data transmission system to which a plurality of data relay apparatuses are connected, a program for the data relay apparatuses,
the management program making the computer execute:
a confirmation step that confirms, for a version of the program instructed by version information of the version of the program to be applied to the data relay apparatuses as instruction information, whether the version of the program can be applicable to the data relay apparatuses by looking up respective version information on the program installed in each of the data relay apparatuses and, for each of the plurality of versions of the program, requirement information for changing that version to a different version; and
an install processing step that installs, in response to the confirmation step determining that the program is applicable, the program in the instructed version to the data relay apparatuses.

12. The computer readable recording medium according to claim 11 having a management program recorded thereon, wherein
the management program makes the computer further execute a selection step that selects the program in another version applicable to the data relay apparatuses on the basis of the requirement information, in response to the confirmation step determining that the program in the instructed version is not applicable,
wherein the install processing step installs the program in the instructed version after installing the version of the program selected by the selection step.

13. The computer readable recording medium according to claim 11 having a management program recorded thereon, wherein order information indicating orders of the plurality of versions of the program is assigned to the program in each version, and
the requirement information includes the step count information related to each version of the program, the step count information indicating a count of at least one step that can be directly changed to, the step count being counted from the each version in accordance with the order.
